(19) United States
(12) Patent Application Publication
(10) Pub. No.: US 2013/0069319 A1
(43) Pub. Date: Mar. 21, 2013

(54) REMOTELY ADJUSTABLE SHAFT SEAL

(71) Applicant: Townley Engineering and Manufacturing Company,, Candler, FL (US)

(72) Inventor: Urs Blattmann, Birmingham, AL (US)

(73) Assignee: Townley Engineering and Manufacturing Company, Inc, Candler, FL (US)

(21) Appl. No.: 13/622,888

(22) Filed: Sep. 19, 2012

Related U.S. Application Data
(60) Provisional application No. 61/536,136, filed on Sep. 19, 2011.

(51) Int. Cl. F16J 15/16; F15B 11/08

(52) U.S. Cl. 277/510; 92/172

(57) ABSTRACT

A shaft seal arrangement includes a stuffing box defining a stuffing box central shaft opening extending around a shaft axis, packing arranged in the stuffing box around the central shaft opening, a packing gland defining a packing gland central shaft opening, and at least one adjuster assembly remotely operable to vary an engagement force between the packing gland and the packing. The adjuster assembly can be arranged around a packing gland stud and include an adjuster piston that is hydraulically operable to advance against the packing gland to vary the engagement force.

### CROSS-REFERENCE TO RELATED APPLICATION

This application claims the benefit of U.S. Provisional Patent Application Ser. No. 61/536,136, filed on Sep. 19, 2011, the contents of which are herein incorporated by reference in their entirety.

### FIELD OF THE INVENTION

The present invention relates to shaft seals for rotating mechanical equipment.

### BACKGROUND OF THE INVENTION

Shaft seals are employed to prevent or minimize leakage around rotating shafts on a wide variety of machines. For example, the majority of centrifugal slurry pumps in heavy duty slurry services throughout the mining industries feature a packed stuffing box type shaft seal. Currently, this seal must be adjusted manually in regular and frequent intervals to function properly.

Referring to FIG. 1, a typical shaft seal arrangement 110 includes a stuffing box 112, lantern ring 114 (or 114A), packing 116, packing gland 118 and assorted fasteners (e.g., stud/bolt 120 or stud 120A). The pump shaft 122, which in most cases is encased by a shaft (wear) sleeve 124, rotates within the stationary shaft seal 110 when the pump is operating—and more specifically, within a central shaft opening of the stuffing box 112. Pressurized water is injected from an external source into a port in the stuffing box 112 from where it flows to the lantern ring 114 for the purpose of lubricating and cooling the shaft sleeve 124 and packing 116, and in the case of slurry pumps, to prevent solids from within the pump to enter the shaft seal 110 area and leak to atmosphere.

In order for this type of arrangement to work properly, a minimum amount of gland water flow is required. The amount of flow can be adjusted by manually tightening or loosening the packing gland adjusting nuts 126, 126A with a suitable wrench. This will adjust the amount of compression on the soft packing material and thus vary the amount of water that will be allowed to leak from the shaft seal. Depending on the type of service and the amount of gland water pressure required, frequent adjustments must be made to maintain proper gland water flow. To perform this adjustment, the pump will have to be shut down and electrically locked out.

In the past, adjustments were made by maintenance personnel while the pumps were operating. More stringent safety regulations imposed on industry have made this common practice impossible due to the close proximity of the shaft seal to the rotating pump shaft. As the pump shaft now has to be completely guarded, ready access to the stuffing box is no longer available to adjust the packing gland of the shaft seal. Instead, the pumps must be shut down and electrically locked out before any work can commence. Any safety guards that are mounted in place will have to be removed. After the adjustment is made, all guards will have to be reinstalled and the pumps will have to be restarted to check for proper sealing performance. This down time is very costly in terms of lost production for the operations, especially on multi-pump pipeline installations. As a result, proper maintenance is often neglected, leading to shorter equipment operating life and excessive repair costs.

### SUMMARY OF THE INVENTION

In view of the foregoing, it is an object of the present invention to provide a way of remotely adjusting the shaft seal is needed while the pumps remain in operation with all safety equipment and guards in place. According to an embodiment of the present invention, a shaft seal arrangement includes a stuffing box defining a stuffing box central shaft opening extending around a shaft axis, packing arranged in the stuffing box around the central shaft opening, a packing gland defining a packing gland central shaft opening, and at least one adjuster assembly remotely operable to vary an engagement force between the packing gland and the packing. The adjuster assembly can be arranged around a packing gland stud and include an adjuster piston that is hydraulically operable to advance against the packing gland to vary the engagement force.

According to an aspect of the present invention, a stud-mounted adjuster assembly includes an adjuster body defining a stud passage and a piston cavity, the stud passage surrounding a stud axis through which a stud is accommodatable so as to extend through the outer body, and an adjuster piston movably arranged in the piston cavity and projectable therefrom in the direction of the stud axis. The adjuster piston and cavity can encircle the stud passage and be advanced against the packing gland around the stud.

According to a method aspect, a method of operating a shaft seal arrangement for rotating machinery includes remotely operating an adjuster assembly to vary an engagement force between a packing gland and packing of the shaft seal arrangement. Advantageously, the adjuster assembly is operated while the rotating machinery remains in operation.

These and other objects, aspects and advantages of the present invention will be better appreciated in view of the drawings and following detailed description of a preferred embodiment.

### BRIEF DESCRIPTION OF THE DRAWINGS

FIG. 1 is a side section view of a typical shaft seal arrangement;

FIGS. 1A-1B are detail sectional views of alternate arrangements for area 1AB of FIG. 1;

FIG. 1C is a detail sectional view of an alternate arrangement for area 1C of FIG. 1;

FIG. 2 is a sectional view of shaft seal arrangement having a remotely operated adjuster assembly, according to an embodiment of the present invention;

FIG. 2A is a detail sectional view of area 2A of FIG. 2;

FIG. 3 is a sectional view of the adjuster assembly of FIG. 2; and

FIG. 4 is an end view of the adjuster assembly of FIG. 3, with hidden components shown in broken lines.

### DETAILED DESCRIPTION OF A PREFERRED EMBODIMENT

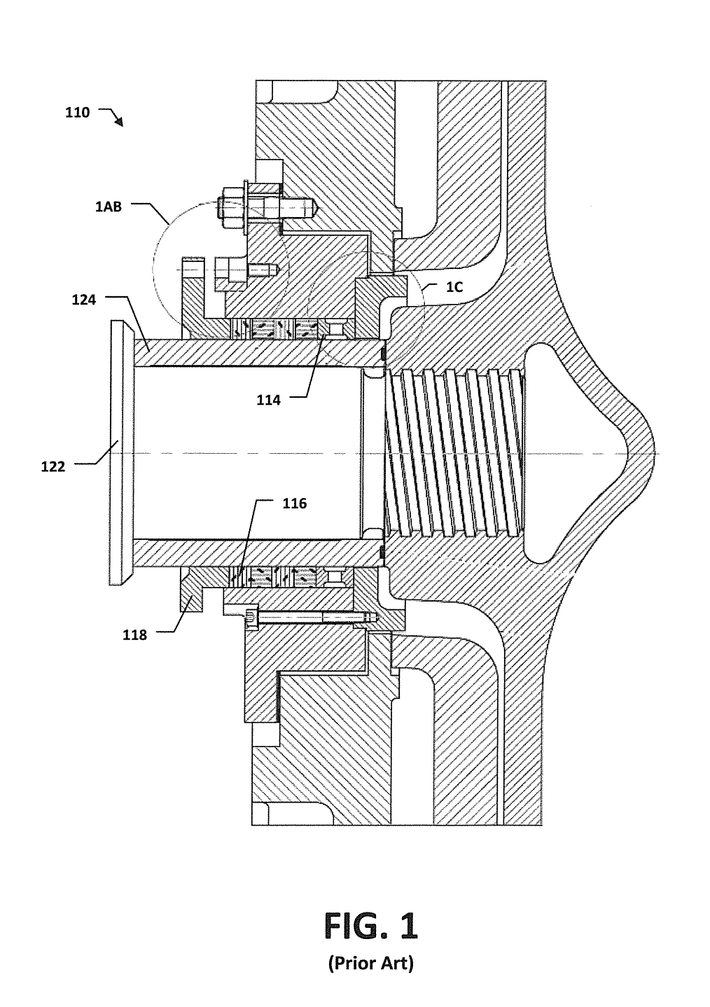

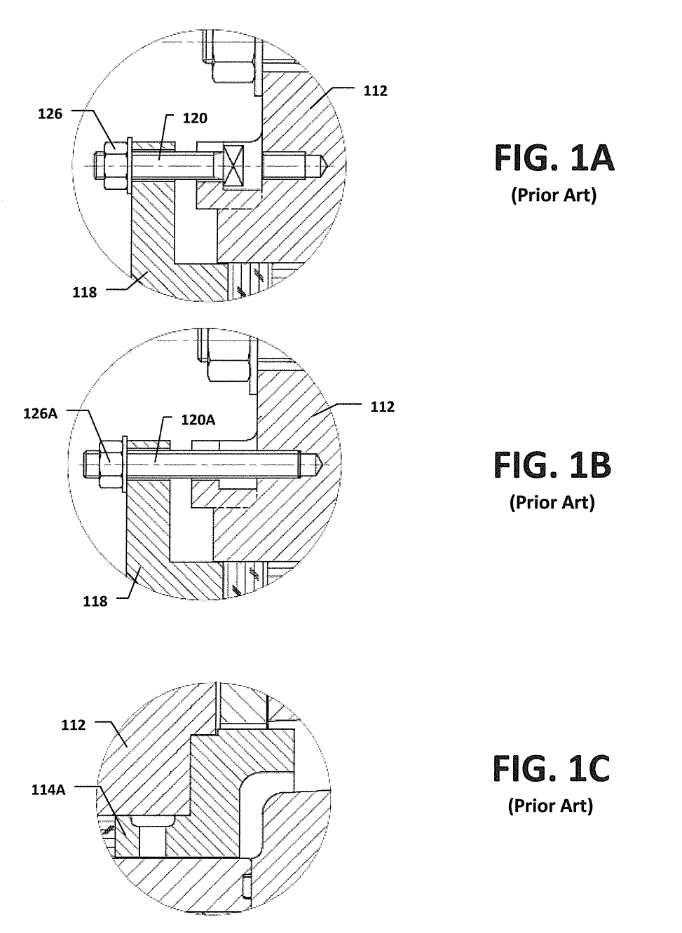

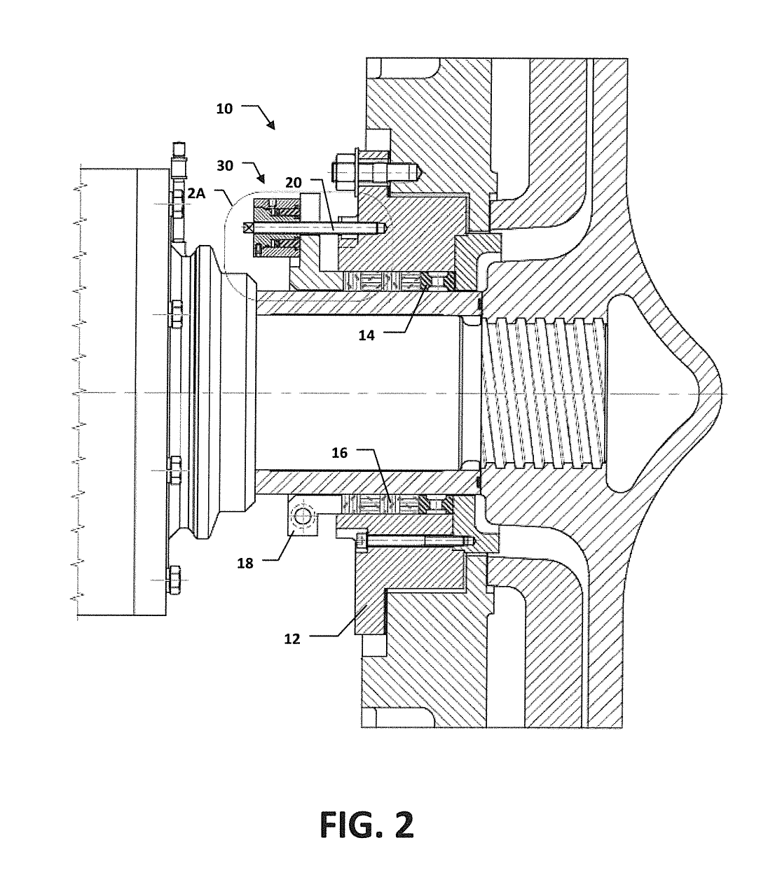

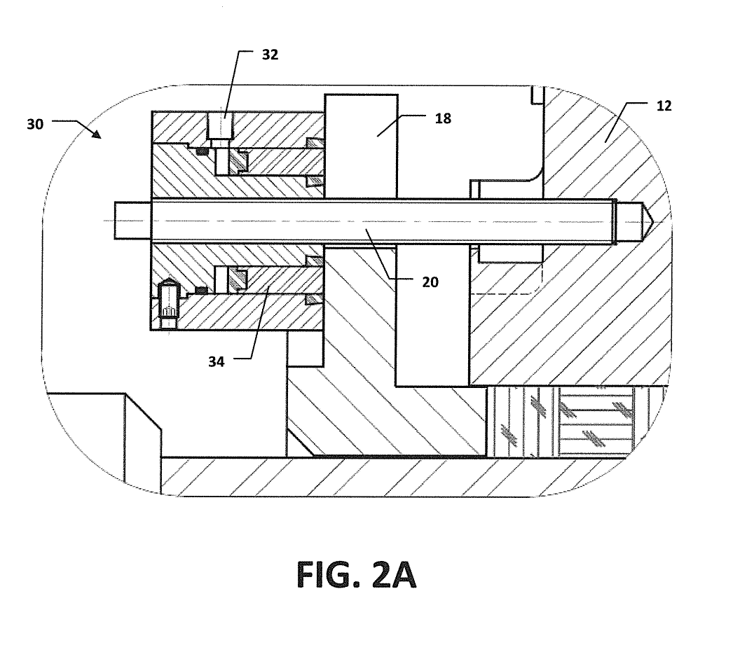

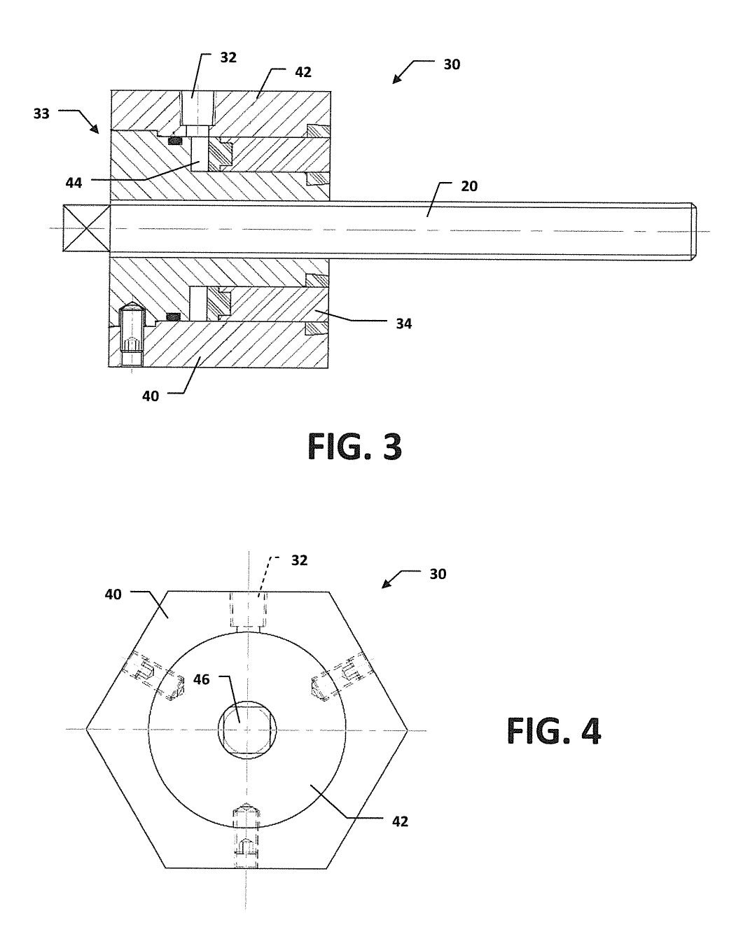

Referring to FIGS. 2 and 3, according to an embodiment of the present invention, a shaft seal arrangement 10 includes a stuffing box 12, lantern ring 14, packing 16, packing gland 18 and studs 20. A remotely operated adjuster assembly 30 is arranged between the packing 18 and an outer end of each stud 20 (only one shown). Studs that connect to the stuffing box in the manners illustrated in FIGS. 1A and 1B could both be readily employed, as could an alternate lantern ring arrangement like that in FIG. 1C.

A remote mounted motive fluid dispenser is permanently connected via suitable hydraulic hoses to a port 32 in an adjuster body 33 of each adjuster assembly 30. The amount of shaft seal water flow can now be adjusted while the pump remains in operation with all safety guards in place by introducing a motive fluid under pressure into the port 32, thus advancing an annular piston 34 within the adjuster assembly 30. The piston 34 in turn advances the packing gland 18 to increase the amount of load on the packing 16 and decrease the amount of water that will be allowed to leak from the seal 10.

The adjuster body 33 can includes concentric outer and inner components 40, 42 between which a piston cavity 44 for the annular piston 34 is defined, surrounding the passage 46 for the stud 20 extending through the inner component. Alternately, the adjuster body 33 can be manufactured as a single piece, with the piston cavity 44 and stud passage 46 machined or otherwise formed therein. The adjuster body 33 can threadingly engage the stud 20.

It will be appreciated from the foregoing, that a shaft seal arrangement 10 including the adjuster assemblies 30 of the present invention allow adjustments to be made while the pump remains in operation, without requiring the removal of any guards. Moreover, because the pump remains in operation, an instant visual check can be performed to determine whether the proper level of adjustment had been made. Additionally, adjuster assemblies 30 according to the present invention can be easily retrofit into existing shaft seal arrangements 10—for instance arrangements.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

What is claimed is:

1. A shaft seal arrangement comprising:
a stuffing box defining a stuffing box central shaft opening extending around a shaft axis;
packing arranged in the stuffing box around the central shaft opening;
a packing gland defining a packing gland central shaft opening, the packing gland engaging the packing, the packing gland opening being arranged coaxially with the stuffing box central shaft opening; and
at least one adjuster assembly remotely operable to vary an engagement force between the packing gland and the packing.

2. The shaft seal arrangement of claim 1, wherein the at least one adjuster assembly includes an adjuster piston movable against the packing gland to increase the engagement force.

3. The shaft seal arrangement of claim 2, wherein the at least one fluid port is defined in the at least one adjuster assembly, such that the adjuster piston is movable by application of fluid to a side thereof.

4. The shaft seal arrangement of claim 1, wherein the packing gland defines at least one packing gland stud opening and the arrangement further comprises at least one stud extending through the at least packing gland stud opening, the at least one stud holding the packing gland in engagement with the packing, the at least one adjuster assembly being mounted on the at least one stud and acting between the stud and the packing gland.

5. The shaft seal arrangement of claim 4, wherein the at least one adjuster assembly includes an adjuster piston movable against the packing gland to increase the engagement force.

6. The shaft seal arrangement of claim 5, wherein the at least one fluid port is defined in the at least one adjuster assembly, such that the adjuster piston is movable by application of fluid to a side thereof.

7. The shaft seal arrangement of claim 4, wherein the adjuster assembly and the adjuster piston thereof coaxially surround the at least one stud.

8. The shaft seal arrangement of claim 4, wherein an end of the at least one stud opposite the adjuster assembly is connected to the stuffing box.

9. The shaft seal arrangement of claim 1, further comprising a lantern ring engaging the packing opposite the packing gland, the lantern ring defining a gland fluid port through which gland water is introduceable, and remotely operating the at least one adjuster assembly to vary the engagement force will vary the flow rate of gland water introduced through the lantern ring.

10. A stud-mounted adjuster assembly comprising:
an adjuster body defining a stud passage and a piston cavity, the stud passage surrounding a stud axis through which a stud is accommodatable so as to extend through the outer body; and
an adjuster piston movably arranged in the piston cavity and projectable therefrom in the direction of the stud axis.

11. The stud-mounted adjuster assembly of claim 10, wherein the piston cavity and adjuster piston at least partially surround the stud axis within the adjuster body.

12. The stud-mounted adjuster assembly of claim 11, wherein the piston cavity and the adjuster piston encircle the stud passage.

13. The stud-mounted adjuster assembly of claim 10, wherein a fluid port is defined in the adjuster body communicating with the piston cavity such that the piston is movable by fluid introduced through the fluid port.

14. The stud-mounted adjuster assembly of claim 10, further comprising the stud accommodated in the stud passage.

15. A method of operating a shaft seal arrangement for rotating machinery, the method comprising:
remotely operating an adjuster assembly to vary an engagement force between a packing gland and packing of the shaft seal arrangement.

16. The method of claim 15, wherein remotely operating the adjuster assembly to vary the engagement force includes advancing an adjuster piston from the adjuster assembly against the packing gland to increase the engagement force.

17. The method of claim 16, wherein advancing the adjuster piston from the adjuster assembly against the packing gland includes introducing fluid between the adjuster piston and an adjuster body of the adjuster.

18. The method of claim 16, wherein the adjuster assembly is mounted on a stud extending through the packing gland.

19. The method of claim 18, wherein the adjuster piston encircles the stud and is advanced against the packing gland therearound.

20. The method of claim 15, wherein the adjuster assembly is remotely operated while the rotating machinery is in operation.
